(19) United States
(12) Patent Application Publication
(10) Pub. No.: US 2026/0183620 A1
(43) Pub. Date: Jul. 2, 2026

(54) GOLF BALL COLLECTION SYSTEM FROM WATER

(71) Applicants: Jonathan Charles Olson, Potterville, MI (US); Gina Lynn Elfenbein, Holt, MI (US)

(72) Inventors: Jonathan Charles Olson, Potterville, MI (US); Gina Lynn Elfenbein, Holt, MI (US)

(21) Appl. No.: 19/003,346

(22) Filed: Dec. 27, 2024

(51) Int. Cl. A63B 47/02; B65G 51/04

(52) U.S. Cl. CPC A63B 47/02; B65G 51/04; B65G 2203/0216

(57) ABSTRACT

A golf ball collection system for water in which errant golf balls are caught in a net or screen and funneled to a common outlet and then moved from the water by a retrieval system. The system also contemplates the use of sensors to count golf balls, recognized damaged golf balls, and recognize signature golf balls.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

There are many aggravations on a golf course for the average player. One such aggravation is the occurrence of bodies of water that seem to collect errant golf balls. Very few of such errant golf balls are ever retrieved by the owners.

After a prior art search by the applicant, there were no water collection systems to be found. What was found was U.S. Patent Publication 2004/0214648 that was published on Oct. 28, 2004, in which a golf practice target system was disclosed. The device was not used or intended to be used in water recovery.

There is shown in U.S. patent publication 2006/0199658 that published on Sep. 7, 2006, a multi-pocket golf net assembly for trapping golf balls. This device is also not intended to be used in water situations.

U.S. Patent publication 2023/0338801 that published on Oct. 26, 2023, to Burdette, et al. deals with systems and apparatus for receiving golf balls using radio frequency identification tags.

### BRIEF SUMMARY OF THE INVENTION

Thus, there is disclosed and claimed herein a first embodiment that is a capture system for golf balls placed in a body of water. The capture system comprises a floating net assembly having an upward depending outside edge. The net assembly has a plurality of weighted tie-downs along the outside edge and the net assembly has a centered opening sufficient in size to allow the passage of golf balls.

In addition, there is a capture assembly comprising a collection funnel attached to a bottom of the centered opening for funneling captured golf balls to an extraction system. The extraction system is selected from a water pumping system, a vacuum system, and a forced air system.

In another embodiment, the capture system can have two or more capture systems and extraction systems that are functionally attached to each other.

In yet another embodiment, there is another capture system for golf balls placed in a body of water. The capture system comprises a floating net assembly having an upward depending outside edge. The net assembly has a plurality of perforated tabs, including tethers, along the outside edge. The tethers are attachable and holdable to soil surrounding the water. The net assembly has a centered opening sufficient in size to allow the passage of golf balls. There is a capture assembly comprising a collection funnel attached to a bottom of the centered opening for funneling captured golf balls to an extraction system, the extraction system selected from a water pumping system, a vacuum system, and a forced air system.

In still another embodiment, there is A capture system for golf balls placed in a body of water. The capture system comprises a net assembly having an upward depending outside edge. The net assembly has a plurality of perforated tabs, including tethers, along the outside edge. The tethers are attachable and holdable to soil surrounding the water. The net assembly has a centered opening sufficient in size to allow the passage of golf balls. There is a capture assembly comprising a collection funnel attached to a bottom of the centered opening for funneling captured golf balls to an extraction system, the extraction system being selected from a water pumping system, a vacuum system, and a forced air system.

Further embodiments include methods of capturing and collecting golf balls from a water environment, using the apparatii as disclosed just Supra.

### BRIEF DESCRIPTION OF THE SEVERAL VIEWS OF THE DRAWING(S)

FIG. 1 is a full top view of a floating collection system using tensionable tethers to support and hold the net.

FIG. 2 is a side view of the apparatus of FIG. 1.

FIG. 3 is a full top view of a floating collection system using weighted tie-downs.

FIG. 4 is a full side view of the apparatus of FIG. 3.

FIG. 5 is a partial view of the device of FIG. 4.

### DETAILED DESCRIPTION OF THE INVENTION

This invention deals with a golf ball collection system for water use in which errant golf balls are caught in a net or screen and funneled to a common outlet and then moved from the water by a retrieval system.

Thus, there are three device embodiments of this invention, a floating collection net with tie downs, a floating collection net with tensionable tethers, and non-floating collection net with tensionable tethers. In addition, there are three method embodiments using the apparatii noted just Supra.

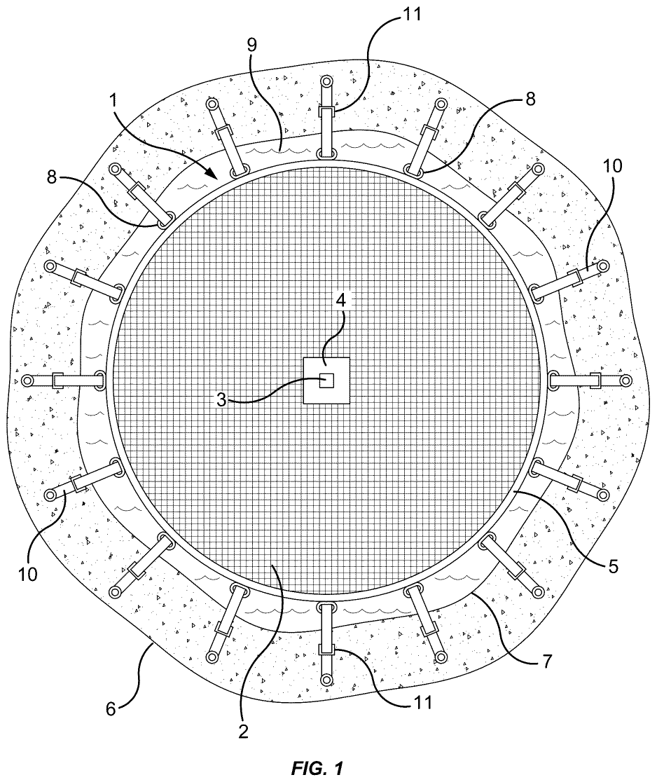

Turning now to FIG. 1, there is shown a full top view of a device of this invention in which the net is floating and is tethered to the shore with tethers.

There is shown the device 1, the net 2, the centered opening 3 and the reinforced area 4 surrounding the centered opening 3. There is also shown the upwardly depending edge 5 of the net 2. The designation 6 is the demarcation of surrounding soil and the demarcation line 7 is the actual shoreline. As noted, the net 2 is held to the surrounding soil 6 and this is accomplished by tabs 8 affixed to the edge 5 of the net 2 and tethers 10 attached to the tabs 8. The tethers can have a tensioning apparatus 11 on then for use when the situation requires that the tethers 10 need adjusting. The number 9 designates the body of water.

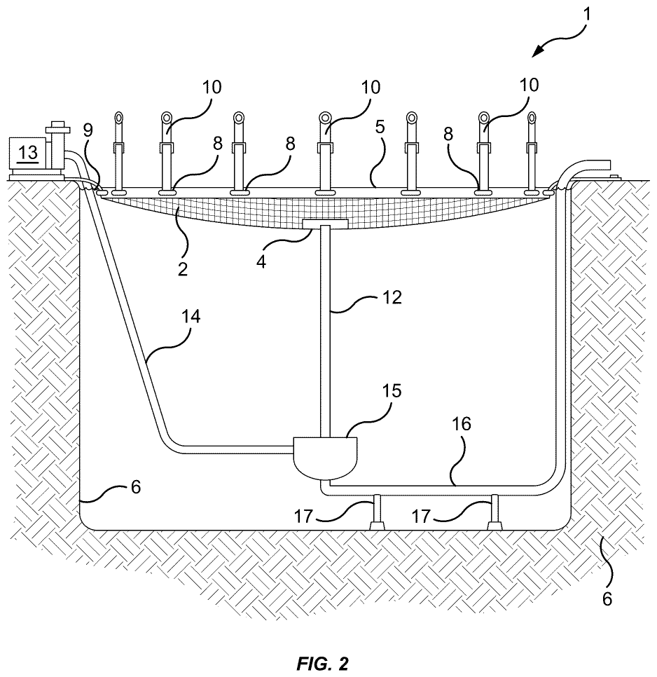

FIG. 2 is a full side view of the device of FIG. 1 wherein a collection system is shown along with the net assembly. There is shown the device 1, tethers 10, tabs 8, edge 5, collection tube 12, pump 13, water line 14, surrounding soil 6, collection container 15, exit pipe 16, and support stands 17. In this instance, the pump is a water pump in which water is used to propel the golf balls out of the container 15 through the pipe 16 to exit on shore.

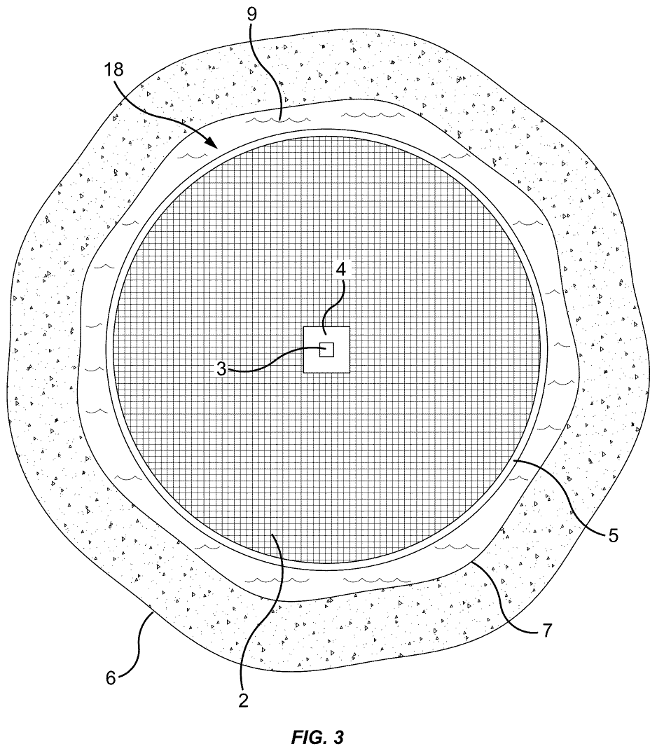

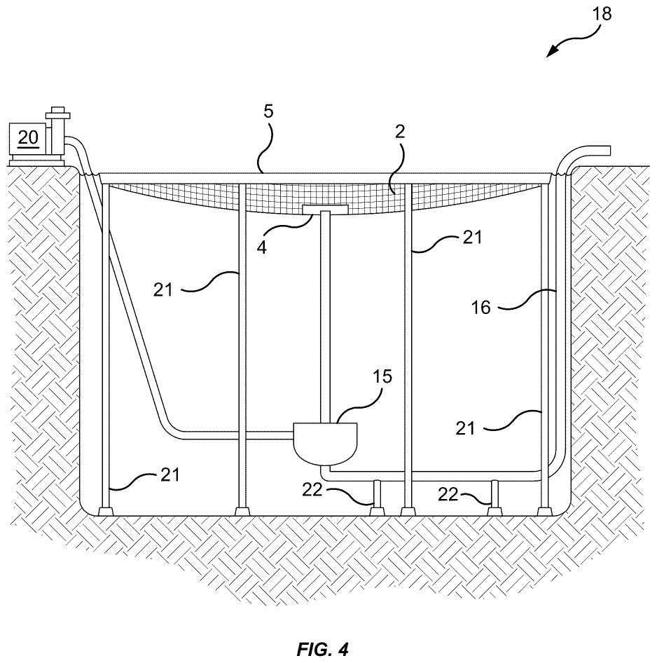

Another embodiment is a combination of floating net and tie-downs as shown in FIGS. 3 and 4 wherein FIG. 3 is a full top view and FIG. 4 is full side view of such a device.

Turning to FIG. 3, there is shown the device 18, the floating net 2, the centered opening 3, the reinforcement 4 of the opening 3, the edge 5, the surrounding soil 6, the shoreline demarcation 7 and water 9.

Shown in FIG. 4 is a full side view of the device 18 of FIG. 3, wherein there is shown the net 2, centered opening 3, reinforced area 4 of the centered opening 3, the edge 5 of the net 2, surrounding soil 6, shoreline demarcation 7 and water 9.

Shown in FIG. 4 is a full side view of the device 18 of FIG. 3 wherein there is shown the net 2, reinforced area 4 of the centered opening 3, the edge 5 of the net 2, surrounding soil 6, shoreline demarcation 7 and water 9. In addition, there is shown an air pump 20, weighted tie-downs 21 for the floating net 2 and support columns 22 to hold the exit pipe 16 in place. In this instance, the pump is an air pump in which pressured air is used to propel the golf balls and any water out of the container 15 through the pipe 16 to exit on shore.

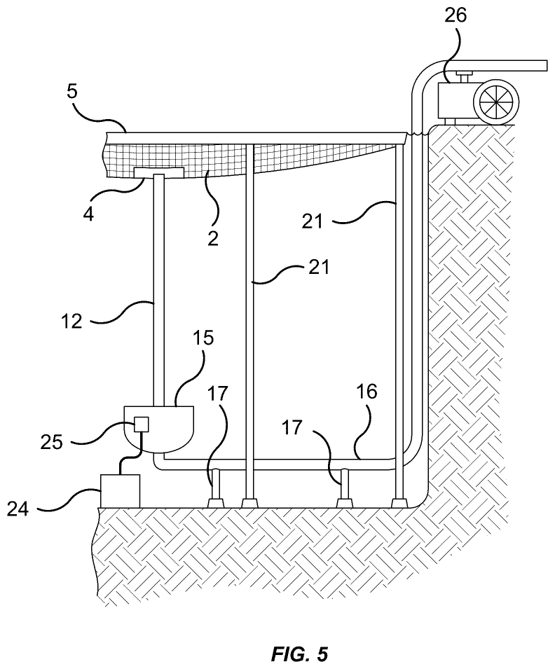

In a third embodiment, there is shown a device 23 in FIG. 5, which is a portion of a device 18 as shown in FIG. 4, however, the device 23 of FIG. 5 is equipped with a sensor system, comprised of electronic ware 24 and sensor 25, to detect golf balls, count golf balls, or recognize signature golf balls. FIG. 5 also shows the location of a vacuum system 26 for drawing golf balls from container 15 through exit pipe 16 to shore.

Another embodiment of a device of this invention is that found in FIG. 1, but the net 2 is not floating and is held in place by tensioned tethers and tabs. The device is essentially stretched in place over a body of water.

Also contemplated within the scope of the claims are methods of retrieving golf balls from bodies of water using the devices claimed in this invention.

What is claimed is:

1. A capture system for golf balls placed in a body of water, said capture system comprising:
A) a floating net assembly having an upward depending outside edge, said net assembly having a plurality of weighted tie-downs along said outside edge, said net assembly having a centered opening sufficient in size to allow the passage of golf balls;
B) a capture assembly comprising a collection funnel attached to a bottom of said centered opening for funneling captured golf balls to an extraction system, said extraction system selected from
A) a water pumping system,
B) a vacuum system, and
C) a forced air system.

2. The capture system as claimed in claim 1 wherein two or more capture systems and extraction systems are functionally attached to each other.

3. The capture system as claimed in claim 1 wherein, in addition, there is a scanner attached to said capture assembly.

4. The capture system as claimed in claim 1 wherein there is a scanner attached to said capture assembly to count golf balls.

5. The capture system as claimed in claim 1 wherein there is a waterproof scanner attached to said capture assembly to recognize damaged golf balls.

6. The capture system as claimed in claim 1 wherein there is a scanner attached to said capture assembly to recognize named golf balls.

7. A capture system for golf balls placed in a body of water, said capture system comprising:
A) a floating net assembly having an upward depending outside edge, said net assembly having a plurality of perforated tabs, including tethers, along said outside edge, said tethers being attachable and holdable to surrounding soil, said net assembly having a centered opening sufficient in size to allow the passage of golf balls;
B) a capture assembly comprising a collection funnel attached to a bottom of said centered opening for funneling captured golf balls to an extraction system, said extraction system selected from
A) a water pumping system,
B) a vacuum system, and
C) a forced air system.

8. The capture system as claimed in claim 7 wherein said tethers are tensionable.

9. The capture system as claimed in claim 7 wherein two or more capture systems and extraction systems are functionally attached to each other.

10. The capture system as claimed in claim 7 wherein, in addition, there is a scanner attached to said capture assembly to count golf balls.

11. The capture system as claimed in claim 7 wherein, in addition, there is a scanner attached to said capture assembly to recognize damaged golf balls.

12. The capture system as claimed in claim 7 wherein there is a scanner attached to said capture assembly to recognize named golf balls.

13. A method of capturing and collecting golf balls from a water environment, said method requiring the use of the capture system as claimed in claim 1.

14. A method of capturing and collecting golf balls from a water environment, said method requiring the use of the capture system as claimed in claim 7.

15. A capture system for golf balls placed in a body of water, said capture system comprising:
A) a net assembly having an upward depending outside edge, said net assembly having a plurality of perforated tabs, including tethers, along said outside edge, said tethers being attachable and holdable to surrounding soil, said net assembly having a centered opening sufficient in size to allow the passage of golf balls;
C) a capture assembly comprising a collection funnel
attached to a bottom of said centered opening for funneling captured golf balls to an extraction system, said extraction system selected from
A) a water pumping system,
B) a vacuum system, and
C) a forced air system.

16. The capture system as claimed in claim 15 wherein said tethers are tensionable.

17. The capture system as claimed in claim 15 wherein two or more capture systems and extraction systems are functionally attached to each other.

18. The capture system as claimed in claim 15 wherein, in addition, there is a scanner attached to said capture assembly to count golf balls.

19. The capture system as claimed in claim 15 wherein, in addition, there is a scanner attached to said capture assembly to recognize damaged golf balls.

20. The capture system as claimed in claim 15 wherein there is a scanner attached to said capture assembly to recognize named golf balls.

21. A method of capturing and collecting golf balls from a water environment, said method requiring the use of the capture system as claimed in claim 15.
